(19) United States
(12) Patent Application Publication
(10) Pub. No.: US 2010/0070955 A1
(43) Pub. Date: Mar. 18, 2010

(54) ALIAS ANALYSIS FOR CONCURRENT SOFTWARE PROGRAMS

(75) Inventor: Vineet Kahlon, Jersey City, NJ (US)

Correspondence Address: BROSEMER, KOLEFAS & ASSOCIATES, LLC (NECL), ONE BETHANY ROAD BUILDING 4 - SUITE #58, HAZLET, NJ, 07730, US

(73) Assignee: NEC LABORATORIES AMERICA, PRINCETON, NJ (US)

(21) Appl. No.: 12/499,374

(22) Filed: Jul. 8, 2009

Related U.S. Application Data
(60) Provisional application No. 61/078,879, filed on Jul. 8, 2008.

(51) Int. Cl. G06F 9/45

(52) U.S. Cl. 717/141

(57) ABSTRACT

A computer-implemented pointer alias-analysis for concurrent software programs utilizing a divide-and-conquer approach, transaction level summarization and parallelization.

### CROSS REFERENCE TO RELATED APPLICATION

This application claims the benefit of U.S. Provisional Patent Application 61/078,879 filed Jul. 8, 2008.

### FIELD OF THE INVENTION

This invention relates generally to the field of computer software and in particular to a computer-implemented method for alias analysis for concurrent computer programs.

### BACKGROUND OF THE INVENTION

The widespread use of concurrent software in contemporary computing systems has necessitated the development of effective debugging methodologies for such multi-threaded software. Concurrent software however, is behaviorally complex involving subtle interactions between multiple threads and therefore is difficult to manually analyze. Particularly difficult to catch arc errors arising out of data race violations.

Fortunately, static analysis has emerged as a powerful technique for detecting potential bugs in large-scale, real-life, software programs. To be effective however, static analyses must generally satisfy two key conflicting criteria namely, accuracy and scalability. Unfortunately, since static analyses are typically performed on heavily abstracted versions of a given software program, they are susceptible to generating false positives.

More recently, dataflow analysis of concurrent software programs has been shown to be a viable technique to reduce bogus error warnings. However, the accuracy and scalability of dataflow analyses of concurrent software programs is dependent upon the precision and efficiency of an underlying pointer analysis. Consequently, an accurate and scalable pointer analysis would represent a significant advance in the art.

### SUMMARY OF THE INVENTION

An advance is made in the art according to the principles of the present invention directed to a computer-implemented method for pointer alias analysis for concurrent software programs.

Viewed from a first aspect, the present invention is directed to a computer implemented method for determining pointer aliases which performs a precise, pointer partition based transaction delineation that takes into account any synchronization constraints and shared variable effects. In sharp contrast to the prior art—the present method operates on concurrent software programs as opposed to the sequential programs dealt with generally in the art.

Operationally, the computer implemented method takes as input a concurrent software program and identifies a set of pointers contained within the concurrent program. The program is then partitioned into a number of distinct partitions. For each of the partitions, a set of transactions are delineated and summaries for the partitions so delineated are generated. From these summaries, a set of aliases is produced and output as desired.

### BRIEF DESCRIPTION OF THE DRAWING

A more complete understanding of the present invention may be realized by reference to the accompanying drawings in which:

FIG. 1 is a block diagram and simple program excerpts showing Steensgaard vs Anderson points-to graphs;

FIG. 2 is a block diagram and simple program excerpt showing Steensgaard vs. Anderson points-to graphs;

FIG. 3 is an example concurrent program;

FIG. 4 is a program excerpt showing complete vs. maximally complete update sequences;

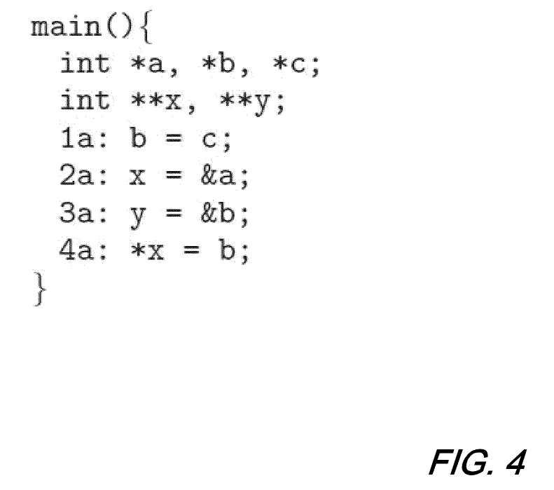

FIG. 5 is an example program;

FIG. 6 is another example program;

FIG. 7 is another example program;

FIG. 8 is a block diagram showing Steensgaard vs. Andersen Points-to Graphs;

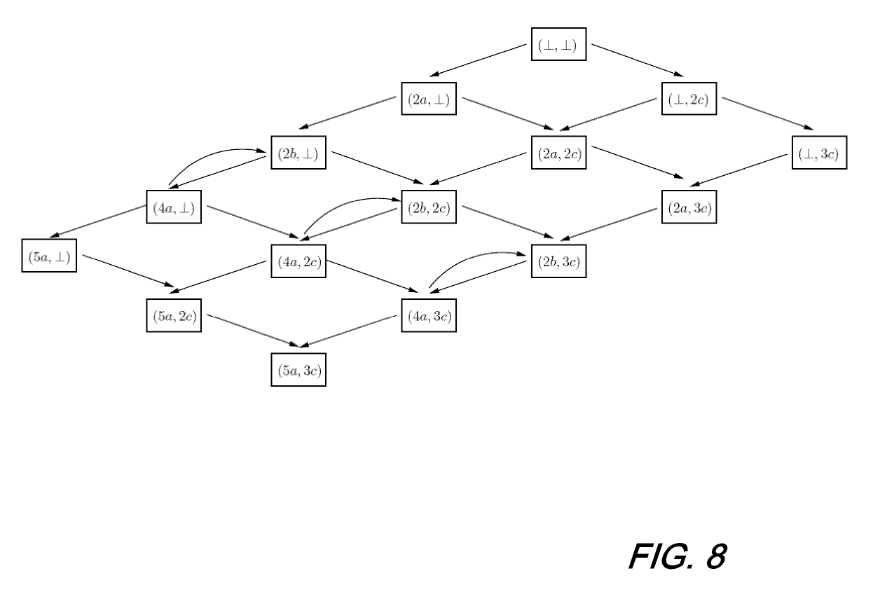

FIG. 9 is an exemplary method for computing FICI clusters; and

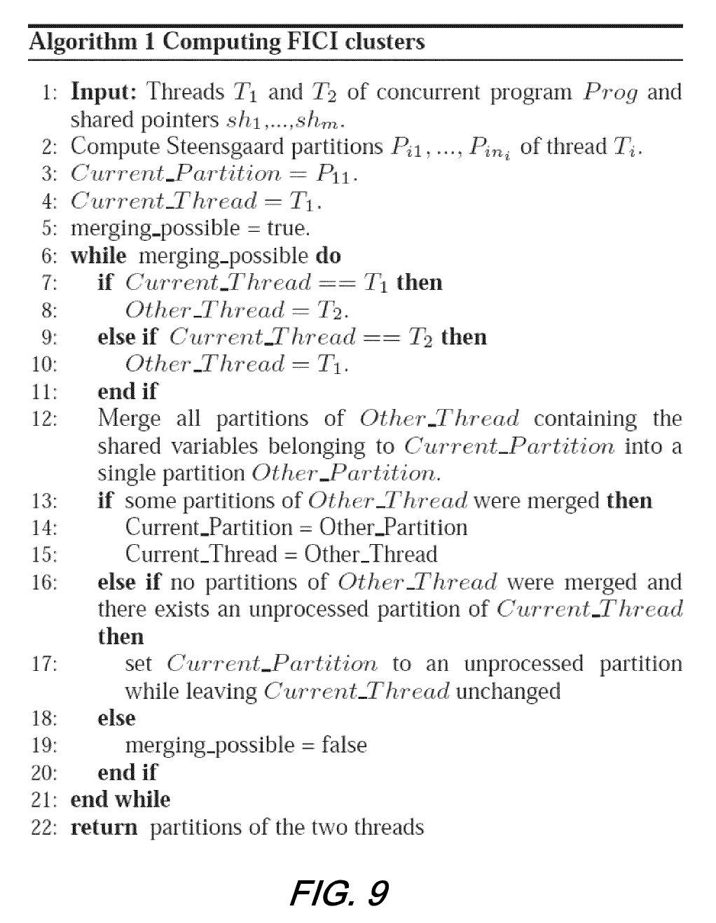

FIG. 10 is an exemplary computer system for performing the method of the instant invention.

### DETAILED DESCRIPTION

The following merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

By way of some further background, it is worth noting that one challenge posed by concurrency—when determining pointer aliases—is that it is particularly difficult to precisely determine how threads—executing concurrently—affect aliasing relations in a given concurrent software program, especially in the presence of shared variables and shared pointers. Indeed, given a location l of thread T in a concurrent program P, the (context/schedule-sensitive) points-to set of a pointer p at l depends not only on the context but also on the interleavings of the various threads comprising P leading to a global state of P with T₁ in location l. Precisely determining how threads other than T could contribute to the points-to set of p at l makes concurrent pointer analysis more challenging technically than sequential pointer analysis.

This is because in a typical concurrent program, threads communicate with each other via synchronization primitives and shared variables that restrict the allowed set of interleavings of statements of these threads.

In order for the context-sensitive points-to analysis to be accurate enough to be useful, we need to isolate as precisely as possible all the allowed set of interleavings that may contribute to the points-to set of p at l. If these interleavings arc not identified precisely enough then the aliasing information determined when performing a context or flow-sensitive analysis turns out to be not much better than a flow-insensitive one

According to an aspect of the present disclosure, my technique is based around the notion of a transaction. Indeed, while in sequential software programs the basic unit of computation is a function (or procedure), for concurrent software programs the basic unit of computation are transactions—i.e. atomically executable regions Of particular note, my notion of transactions is not to be confused with software transactions. In particular and as used herein, a sequence of consecutive statements in a thread constitutes a transaction with respect to a given alias analysis if—upon execution—it atomically does not change the output of the alias analysis. Note that the definition of a transaction is contingent upon the analysis being carried out. This is because different analysis, e.g., flow-sensitive vs. flow-insensitive, may induce different transactions.

As may now be appreciated, transactions are well-suited for carrying out concurrent dataflow analysis of concurrent programs for—at least—two reasons.

First, transactions arc a convenient way to capture thread interference. Indeed, a sequence of statements in a given thread constitutes a transaction only if the interleaving of a statement of any other thread within this sequence cannot affect aliasing relations. As a result analysis performed according to the present disclosure need to consider context switches only at transaction boundaries.

Second, since transaction arc executed atomically, summarization for an alias analysis may be performed for a transaction functional summarization for sequential software programs. These summaries can then be composed based upon the sensitivity of the analysis, e.g., flow, context or schedule, to yield precise aliases.

Two computational challenges facing a transaction-based approach for pointer analysis of concurrent software programs are: 1) the identification of the transactions precisely, and 2) the efficient determination of transaction summaries.

If we choose to ignore interleaving constraints arising from synchronization primitives and shared variables then we need to consider a context switch at every statement with an assignment to a shared pointer. This is because such statement can modify the global aliasing relation. This—in turn—may lead to too many context switches, i.e., small transactions.

However, by incorporating scheduling constraints arising out of synchronization statements, e.g., locks or wait/notify statements, and shared variables, we may increase the granularity of the transactions. This makes our alias analysis more precise as it eliminates false scenarios in which other threads may contribute aliases of pointers at a given location.

Yet another important benefit of large transactions is the increase in efficiency. More particularly, a small number of large transactions means that we need to compute aliases only for a small number of transactions making our analysis more scalable. Thus identifying large transactions is important for both scalability as well as precision.

A key observation made is that apart from synchronization constraints the size of transactions can be increased via locality of reference. Towards that end, we first use an efficient and scalable analysis to small subsets of pointers—called clusters—that have the property that the computation of the aliases of a pointer in a software program can be reduced to the computation of its aliases in each of the small clusters in which it appears. Thus, a software program can be reduced to the computation of its aliases in each of the small clusters in which it appears. This, in effect, decomposes the pointer analysis problem into much smaller sub-problems where—instead of carrying out the pointer analysis for all pointers in the software program, it suffices to carry out separate pointer analysis for each small cluster.

Furthermore, given a cluster, only statements that could potentially modify aliases of pointers in that cluster need be considered. Thus each cluster induces a (usually small) subset of statements of the given program to which pointer can be restricted thereby greatly enhancing its scalability. Once this partitioning has been accomplished a highly accurate pointer analysis can then be leveraged.

Advantageously, the relatively small size of each cluster offsets the higher computational complexity of this additional analysis. Note also that even though in a typically C software program the density of statements that arc pointer assignments can be quire large, the density of such statements that affect pointers in a given cluster may be quite small. Due to this reduced density for every partition, we can—by making transaction delineation cluster-specific—greatly increase the granularity of the transactions.

An added benefit is that if a given cluster does not contain any shared pointers, then all pointers in that cluster belong only to a single thread. For such pointers, the alias analysis can be reduced to (sequential software program) alias analysis for just this thread. Thus, a full blown concurrent pointer analysis needs to be carried out only for partitions with a shared pointer access which are typically very few in number.

Thus the set of relevant interleavings to explore, or equivalently, the set of transactions are governed by: 1) the partition under consideration and 2) scheduling constraints enforced by a) synchronization primitives and shared variables.

We start bootstrapping by applying the highly scalable Steensgaards analysis to identify clusters as points-to sets defined by the (Steensgaard) points-to graph. Since Steensgaard's analysis is bidirectional, it turns out that these clusters are, in fact, equivalence classes of pointers and therefore the resulting clusters arc referred to as Steensgaard Partitions. Note that Steensgaard analysis needs to be carried out in a concurrent setting.

According to the present disclosure, a new modular strategy for Steensgaard's analysis for concurrent software programs is described which reduces Steensgaard's analysis for a concurrent software program to its individual threads. As well be shown, because Steensgaard's analysis has super-linear time complexity, the modular strategy described herein is more efficient that carrying out a whole Steensgaard's analysis.

For a Steensgaard partition containing no shared pointers, we advantageously need to carry out only a sequential pointer analysis. For partitions that contain at least one shared pointer, we need to delineate transactions.

Given such a partition P, we first slice the given concurrent software program with respect to the partition, i.e., remove statements which cannot affect aliases of pointers in P. We encode the transactions of a concurrent software program in the form of a transaction graph.

In determining the transaction graph we need to take into account the affect of both synchronization primitives and shared variables. Transaction delineation, however is undecidable both for threads interacting (i) purely via synchronization primitives such as lock only or wait/notify statements only, or (ii) purely via shared variables. As can be appreciated, a decision problem is undecidable if no algorithm can decide it.

In order to achieve decidability for threads interacting purely via synchronization primitives, the method according to the present disclosure exploits programming patterns such as nested locks, parameterization, and bounded languages which among them are applicable to and “cover” most practical software programs. Synchronization constraints—resulting from shared variables—arc more semantic in nature conditional statements in code as one needs to reason about values of variable involved in the conditional statements.

These values arc not easy to deduce statically. In order to incorporate constraints arising out of shared (and local) variables, sound invariants such as ranges, octagons and polyhedra are exploited. The invariants capture constraints imposed by shared variables. By synergistically combing the effect of shared variables, synchronization primitives and Steensgaard partitioning, the method of the present disclosure generates highly relined precise transactions.

Once transactions have been delineated precisely, summarization at the transaction level—instead of the functional level—is then performed. Advantageously, the summarization is based on the notion of complete update sequences which is more succinct than summarization based on points-to-graphs. Of further advantage, composing transaction-level summaries provides precise concurrent aliases for flow context and schedule sensitive alias analysis.

It is notable that most scalable pointer alias analyses for C software programs have been context or flow-insensitive. Steensgaard is believed to be the first to propose a unification based and context-insensitive pointer analysis. The unification based approach was subsequently extended to give a more accurate one-flow analysis that has one-level of inclusion constraints and bridges the “precision gulf” between Steensgaards and Andersen's analysis.

In addition, inclusion-based methods have been explored in an attempt to push scalability limits of alias analysis, and for those applications where flow-sensitivity is not important, context-sensitive but flow-insensitive alias analysis have been expired.

The idea of partitioning the set of pointers in the given software program clusters and performing an alias analysis separately on each individual cluster has been explored before. However, such clustering was based on treating pointers, references or dereferences thereof, purely as syntactic objects and by computing a transitive closure over them with respect to the equality relation. A clustering based on Steensgaard's analysis takes into account not just assignments between pointers (at the same level in Steensgaard's hierarchy) but also points-to relation between objects (at different levels in the hierarchy). Consequently, Steensgaard partitions are much more refined. i.e., smaller in size than the ones on purely syntactic criteria. Furthermore, cascading of several analyses for increasing precision via cluster refinement to the best of our knowledge, not been considered before.

In summary, a method according to the present disclosure will provide a framework for scalable flow and context-sensitive pointer alias analysis that provides: 1) scalability as well as accuracy by applying a series of analysis in a cascaded manner, 2) is flexible, 3) is fully autonomic—without requiring human intervention, and 4) provides a summarization technique that is succinct.

### Motivating Example

For sequential software programs the basic unit of computation is a function (or procedure). For concurrent software programs however, the basic unit of computation is a transaction, i.e., an atomically executable region of software program code. Thus the natural analogue of a context-sensitive analysis for the sequential domain is a transaction sensitive analysis for the concurrent domain. Note that it is possible to carry out a context sensitive cpt wherein the goal is to find aliases of a pointers at a given pair of locations in two different threads in their respective contexts. Note further that a function which accesses shared access will in general be split into multiple transactions. Thus a transaction sensitive analysis is more refined that a context sensitive one.

While for certain applications, a transaction level analysis of a concurrent software program is important, it might suffer inefficiencies for the same reason as a context-sensitive analysis, that is the number of transaction scenarios can easily blow up. Accordingly, for the method of the instant application, we present a series of analysis pointer analysis for concurrent software programs of increasing precision, flow sensitive (FS); flow and context sensitive (FSCS) and flow and scenario sensitive (FSSS).

Even with the advantages presented above, there are a number of challenges however. First, any kind of analysis of a concurrent software program begins with precise transaction delineation. Indeed, a key step in any concurrent software program analysis is to determine how threads could interfere with each other, i.e., modify dataflow facts at each others' program locations.

Transaction delineation is a crucial part in dataflow analysis of concurrent software programs as it directly governs the sensitivity and scalability of the analysis. However, when any standard synchronization mechanism commonly used in practice such as locks, semaphores and wait/notify are used in the software program, barrier transaction delineation becomes undecidable.

Second, In order to capture, we need to summarize at the transaction boundaries, or function boundaries accordingly as the analysis if scenario or context sensitive. Traditionally, summarization has been carried out in terms of points-t to graph—which are not particularly compact. According to the present disclosure, we show that update sequences are well-suited for concurrent pointer analysis.

A motivation of the method of the instant disclosure were due—in part—to challenges faced due to an imprecise alias analysis while analyzing a video decoder software application. One goal of that analysis was to establish data-race and deadlock freedom of a parallelized version of an existing serial video decoder. The parallelization was carried out by maintaining the frames to be decoded in a global data structure while simultaneously execution threads operating on different parts of the data structure.

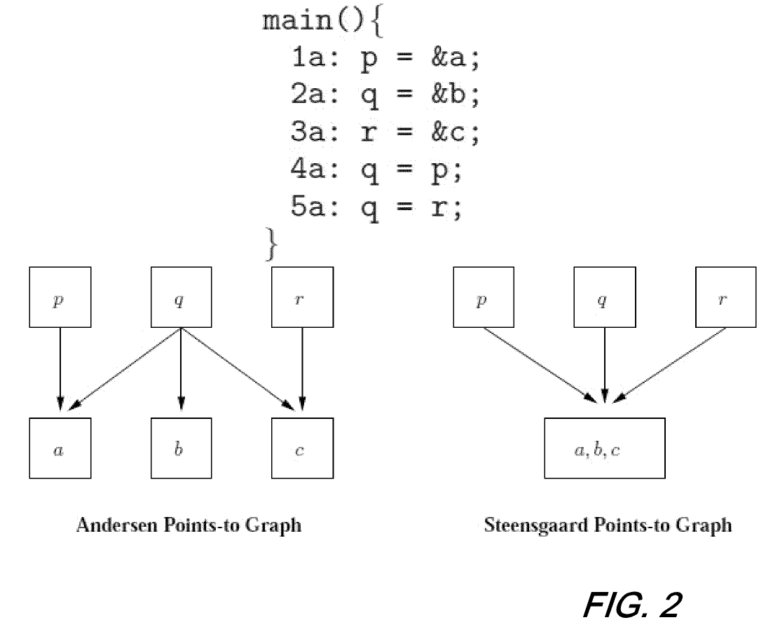

In our example these disjoint regions are accessed via pointers to structures g₁ and g₂ (see FIG. 2). The main thread running, namely parallel_decode forks off two threads at locations 1a and 2a which we denote by T₁ and T₂.

The threads are supposed to work in a pipelined fashion. Thus, although g₁ and g₂ do not necessarily occupy different areas in memory, the threads are supposed to execute different operations in a staggered fashion. However—as implemented—improper staggering resulted in a data race. Some of the data races were fixed by the semaphore send and wait statements 3b and 1c (shown commented out in the original version).

In that original version—i.e., without the semaphore statements—the pointer q₁ and q₂ could be aliased to both g₁→ƒ and g₂→ƒ. Since shared memory locations can be accessed via both g₁ and g₂, locations 2b and 3c should be flagged with data race warnings. If however, the semaphore post and wait statements are introduced as shown in FIG. 2, then a causality constraint is introduced wherein 3b must be executed before 2c. Due to this constraint, we see that Q⊂P p→ƒ cannot be aliased to both g₁→ƒ and g₂→ƒ at location 2b but only g₁→ƒ. Note that in determining the aliases of p at locations 2b and 3c if we had ignored synchronization constraints imposed by the semaphore post and wait statements then we would have picked up both g₁→ƒ and g₂→ƒ as aliases of q.

Since many important analysis of concurrent programs including dataflow analysis rely on a precise underlying alias analysis, such an imprecision resulting from accurately factoring in concurrency related constraints can impact the accuracy of any analysis dependent on aliasing. Accordingly, concurrency constraints need to be taken into account while doing concurrent analysis. As can be readily appreciated, this is but one significant difference between sequential and concurrent pointer analysis.

One may appreciate the problem of determining how concurrent execution of threads can affect aliases of pointers at control locations in either thread as one of determining pairwise reachability. Indeed, in the example presented above, one reason why q was aliased to both g₁→ƒ and g₂→ƒ is that locations 2b and 3c are simultaneously reachable. Such a situation is oftentimes referred to by those skilled in the art as pairwise reachability.

Transaction Level Summarization and Schedule-Sensitivity: Our goal then, is to perform context-sensitive alias analysis pointers in a given thread. This is important for data race detection and has been previously documented. Real-life software programs typically have a large number of small functions that give rise to a large number of contexts that grow exponentially with the number of functions of the given program. This—in turn—makes it quite difficult to pre-determine and store the aliases of each program for each context. For sequential software programs, scalability of fscs-alias is obtained via summarization.

At this point, those skilled in the art will appreciate that concurrency complicates the problem in at least two ways. First, aliases at a location in a given thread depend not only on the context but also on the scheduling of the thread before the location. Therefore, in order to compute the aliases correctly we need a schedule-sensitive analysis. As can be appreciated, this can easily blow up as each context in a given thread can now be reached under several schedules. Given that even context-sensitive analysis is intractable, a schedule sensitive analysis can be even more intractable.

Second, since within the execution of each function other threads can interfere. Thus shared objects arc accessed in a given function whose value is schedule dependent. Consequently, an important implication is that one cannot, in general, build meaningful succinct summaries for such functions. In other words, summarization is better done at a transaction level as opposed to at the function level. This is because a transaction can be executed atomically and is therefore the basic unit of computations. For some structured parallel software programs—in which thread creation and join can happen only within one function—it is possible to summarize.

Still another reason that transaction level cpt is important is that it has been observed—in practice—to uncover frequently occurring concurrency bugs like data races it is enough to analyze a software program for a few context switches. In fact, there is data supporting the fact that up to two context switches are sufficient to uncover most data race errors. Fixing the context switches help us to provide more refined aliases.

Equivalently, one may view the problem of determining interference across threads as one delineating transactions, i.e. sections of code that can be executed atomically, based on the dataflow analysis being carried out. The various interleavings of these atomic sections then determines interferences across threads.

This question, in turn, boils down to one of pairwise reachability, i.e., whether a given pair of control locations in two different threads arc simultaneously reachable. Indeed, in a global state g, a context switch is required at location l of thread T where a shared variable sh is accessed only if starting. at g. Some other thread currently at location m can reach another location m' with an access to sh that conflicts with l, i.e. l and m′ arc pairwise reachable from/and m. In that case, we need to consider both interleavings wherein either l or m′ is executed first thus requiring a context switch at l.

A simple strategy for dataflow analysis of concurrent software programs comprises three main steps: (i) compute the analysis-specific abstract interpretation of the concurrent program, (ii) delineate the transactions, and (iii) compute the dataflow facts on the transition graph resulting by taking all necessary interleavings of the transactions.

Bootstrapping

For a given software program Prog, we let P denote the set of all pointers of Prog. Then, for Q⊂P we use St_{Q} to denote the set of all pointers of Prog. Then, for Q⊂P, we use St_{Q} to denote the set of statements of Prog executing which may affect the aliases of some pointer in Q. Furthermore, for qεQ Alias (q, St_{Q}) denotes the set of aliases of q in a program Prog_{Q} resulting from Prog where each assignment statement not in St_{Q} is replaced by a skip statement and all conditional statements of Prog are treated as evaluating to true. In other words, all statements in Prog other than those in St_{Q} are ignored in Prog_{Q}.

One goal of this is to show how to determine subsets P₁, . . . , Pₘ of P such that: (i) P=∪ᵢPᵢ; (ii) For each pεP, Alias(p,St_{P})=∪ᵢAlias(p,St_{P}_{ᵢ}); and (iii) the maximum cardinality of Pᵢ and of St_{P} over all i is small. This is required in order to ensure scalability in determining the sets Alias (p,St_{P}).

Note that goal (ii) allows us to decompose the determination of aliases for each pointer pεP in the given software program to only determining aliases of p with respect to each of the subsets P, in the software program Prog_{Pi}. This advantageously enables us to leverage divide and conquer. However, in order to accomplish this decomposition, care must be taken in constructing the sets which need to be defined in a way so as not to miss any aliases

We refer to sets P₁, . . . Pₙ satisfying conditions (i) and (ii} above as a Disjunctive Alias Cover. Furthermore, if the sets P₁, . . . Pₙ are all disjoint, then they are referred to as a Disjoint Alias Cover.

We assume, for the sake of simplicity, that each pointer assignment in the given software program is one of the following four types: (i) x=y; (ii) x=&y; (iii)*x=y; and (iv) x=*y. These four types capture the main issues in pointer alias analysis. The general case may be handled with minor modifications to our analysis. Recursion is allowed. Heaps are handled by representing a memory allocation at a software program location loc by a statement of the form: p=&alloc_{loc}. A memory deallocation is replaced by a statement of the form p=NULL.

We flatten all structures by replacing them with collections of separate variables—one for each field. This converts all accesses to fields of structures into regular assignments between such variables. While this was required in our framework for model checking programs, an important side benefit is that it makes our pointer analysis field sensitive. Pointer arithmetic is, for now, handled in a nave manner by aliasing all pointer operands with the resulting pointer.

In the interest of brevity, we touch on (the now standard) Steensgaard's analysis and associated terminology like points-to relations. Steensgaard points-to graph, etc., only briefly without providing a more formal description.

Concurrent FICI-Aliases from Sequential FICI-Aliases

We may now show how to determine concurrent FICI-aliases given sequential (thread-local) FICI-aliases of each pointer. This is not only an important problem in its own right, but is also useful for generalizing bootstrapping to concurrent programs.

For concurrent programs we need to keep track of the effects of operations of all threads on the points-to relations between entities. However, note that How and context insensitivity also implies schedule insensitivity. Thus we need not take the different schedules into account while computing the FISI aliases.

In computing sequential FICI-aliases, we treat the given program as a set of statements, and ignore their order of execution. For concurrent FISI analysis—since the scheduling of the threads is irrelevant—we follow a similar approach and treat the given software program as set of statements irrespective of which thread they belong to.

Thread fork operations arc treated as function calls, viz., the arguments arc treated as passed by value and arc therefore replaced by assignments to fork call parameters. Note that if the complexity of A is O(ƒ(n)), where n is the size of the given concurrent program or O(ƒ(n₁+ . . . +nₖ)) where n₁+ . . . +nₖ arc the number of statements in the given threads.

Exploiting Modularity to Improve Complexity

If ƒ is a linear function, then carrying out the analysis for the entire concurrent software program as opposed to each thread individually does not make any difference. If, on the other hand, ƒ is a super-linear function then carrying out the analysis separately for each thread has complexity benefits. Indeed, the complexity of carrying out the analysis thread locally can relieve the overall complexity of the concurrent FICI analysis.

We start by observing that carrying out the FICI analysis individually each thread must under-approximate the aliases of pointers, The reason for this is that pointers in different threads that point-to the same shared memory location arc aliased to each other. Such aliases arc hard to discover via thread local analyses alone.

We then show how to concurrent Steensgaard aliases from sequential Steensgaard aliases. Note that Steensgaard's analysis partitions the set of pointers of a thread into partitions wherein all pointers in a given partition are (Steensgaard) aliased to each other. All that one needs to do in order to determine concurrent Steensgaard aliases is to merge partitions of two different threads containing at least one common shared variable. Note that merging two partitions may, in turn, result in further merging.

Indeed, consider two partitions in one thread one containing shared variables sh₁ and sh₂ while the other contains shared variables sh₃ and sh₄. These partitions need to be merged. However, this merging causes sh₃ and sh₄ to be in the wrong thread.

In general, this merging of partitions across two threads is carried out via a fix-point computation. More particularly, we start with Steensgaard partitions computed individually for the two threads. To start the merging process we pick a partition P₁₁ for thread T₁ (step 1). Then we merge all partitions belonging to the other thread containing the shared variable belonging to P₁₁. This is because all such shared variables arc aliased to each other in T₁, and therefore should also be fici-aliased to each other in T₂. If some partitions of T₂ were merged resulting in a new partition Q, then that might, in turn, cause some partitions of T₁ to be merged. Thus we make Q the current partition and merge all partitions of T₁ that contain shared variables belonging to Q. This process of going back and forth across threads continues until we can no longer cause any merging.

Suppose, for example, we are currently processing a partition of thread T₁. Then, if there is any partition of T₁ that we have not already processed (and which therefore cause some partitions of T₁ to be merged) then we next consider such a partition and start the process again. Once all of the partitions of a particular thread have been exhausted, no further merging is possible and the process terminates.

Steensgaard Partitioning

In Steensgaard's analysis, aliasing information is maintained as a relation over abstract memory locations. Every location l is associated with a label or set of symbols φ and holds some content C which is an abstract pointer value.

Points-to information between abstract pointers is stored as a points-to graph which is a directed graph whose nodes represent sets of objects and edges encode the points-to relation between them. Intuitively, an edge e: v₁→v₂ from nodes v₁ to v₂ represents the fact that a symbol in v₁ may point to some symbol in the set represented by v₂. The effect of an assignment from pointers y to x is to equate the contents of the location associated with y to x. This is carried out via unification of the locations pointed-to by y and x into one unique location and if necessary propagating the unification to their successors in the points-to graph. Assignments involving referencing or dereferencing of pointers are handled similarly. Since Steensgaard's analysis does not take the directionality of assignments into account, it is bidirectional. This makes it less precise but highly scalable. FIG. 2 shows the Steensgaard points-to graph for a small example.

Steensgaard Points-To Hierarchy

One key feature of Steensgaard's analysis that we are interested in is the well known fact that the points-to sets so generated are equivalence classes. Hence these sets define a partitioning of the set of all pointers in the program into disjoint subsets that respect the aliasing relation, i.e., a pointer can only to be aliased to pointers within its own partition. We shall henceforth refer to each equivalence class of pointers generated by Steensgaard's analysis as a Steensgaard Partition.

For a pointer p, let n_{P} denote the node in the Steensgaard points-to graph representing the Steensgaard partition containint p. A Steensgaard points-to graph defines an ordering on the pointers in P which we refere to as the Steensgaard points-to hierarchy. For pointers p, qεQ we say that p is higher than q in the Steensgaard points-to hierarchy denoted by p>q, or equivalently, by q<p if n_{P} and n_{q} are distinct nodes and there is a path from nᵢ, to n_{q} in the Steensgaard points-to graph. Also, we write p˜q to mean that p and q both belong to the same Steensgaard partition. The Steensgaard depth of a pointer p is the length of the longest path in the Steensgaard points-to graph leading to node n_{P}. That the notion of Steensgaard depth is well defined and follows from the fact that a Steensgaard points-to graph is a forest of directed acyclic graphs.

Notably, the Steensgaard points-to graph should not be confused with a graph of the points-to relation. The graph of the points-to relation can contain cycles. However, a Steensgaard points-to graph which is over sets (equivalence classes) of pointers and not individual pointers is always acyclic. Consider the assignment *p=p which creates a loop in the graph of the points-to relation. Since both *p and p belong to the same Steensgaard equivalence class (p˜*p) they will be represented by the same node in the Steensgaard points-to graph. Since the Steensgaard points-to graph only has edges between different nodes, we can deduce that it will be acyclic for the above statement. This ensures that the < relation introduced above is well-defined. Note that such cycles in the points-to graph can arise in common situations involving cyclic data structures, void pointers, etd. We therefore distinguish between the points-to hierarchy and the points-to relation. Henceforth, whenever we use the term points-to hierarchy, we mean the Steensgaard points-to hierarchy.

Schedule/Context-Sensitive Alias Analysis

We have shown that the schedule/context sensitive alias analysis for a concurrent software program P can be restricted to each of the pointer partitions realized via an FICI-alias analysis described previously. We now describe the summarization-based approach for determining context/schedule sensitive aliases for pointers in a given FICI-partition.

Given a location t of thread T in a concurrent software program P, the (context/schedule-sensitive) points-to set of a pointer p at l depends not only on the context but also on the interleavings of the various threads comprising P leading to a global state of P with T₁ in location l. Determining precisely how threads other than T could contribute to the points-to set of p at l makes concurrent pointer analysis technically more challenging than sequential pointer analysis. This is because in a typical concurrent software program, threads communicate with each other via synchronization primitives and shared variables that restrict the allowed set of interleavings of statements of these threads. In order for the context-sensitive points-to analysis to be accurate enough to be useful, we need to isolate as precisely as possible all the allowed set of interleavings that may contribute to the points-to set of p at l. In fact we show that the set of interleavings that we need to consider is governed by 1) Scheduling constraints enforced by i) synchronization primitives, and ii) shared variables, as well as on; and 2) the FICI-partition under construction.

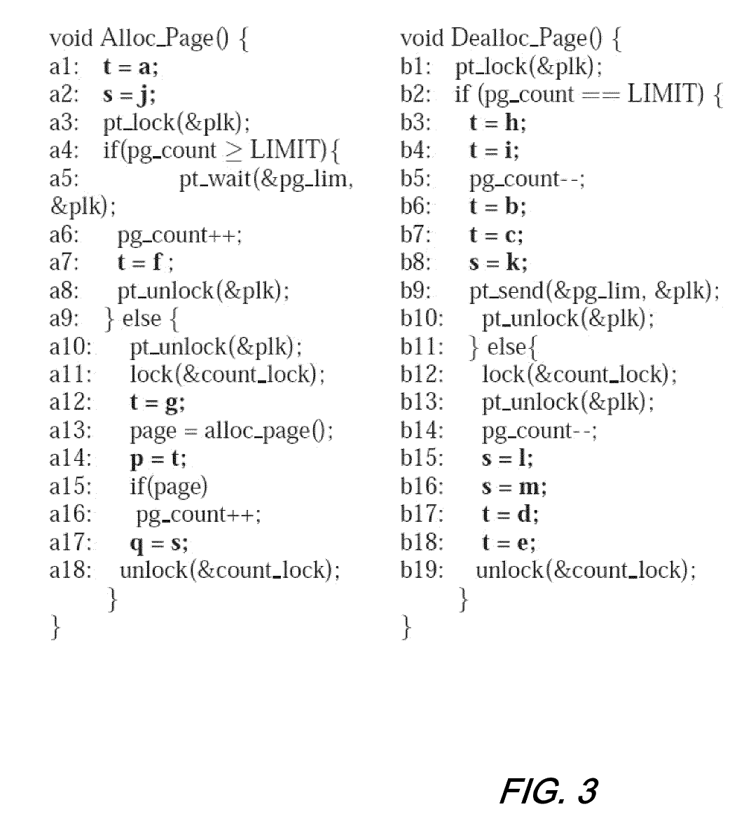

Consider the example of concurrent software program P shown in FIG. 3 where multiple threads may be executing the Alloc_page and Dealloc_page routines. For clarity, all pointer assignments have been highlighted in bold. A concurrent Steensgaard's analysis of P, as described previously results in two partitions namely, P₁={p, t, a, b, c, d, e, f, g, h, i} and P₂={q, s, j, k, l, m}. Consider the partition P₁. Suppose that we are interested in the aliases of pεP₁ at location a14 of thread T₁ of executing Alloc_page. From the previous discussion, we have that in order to determine aliases of any pointer in P we need only consider statements of P in St_{P}_{ᵢ}. Thus any statement other that (i) those in St_{P}_{ᵢ} and (ii) those involving synchronization primitives, e.g., locking/unlocking statements of P cannot affect the points-to sets of any pointer in P₁ and can, therefore be sliced away. In our example, all assignments to pointers in P₂ are remobed when considering the partition P₁.

Interleaving Constraints Imposed by Synchronization Primitives

At location a14, pointer p is aliased to t due to the assignment statement p=t. Thus all aliases of t at location a14 are also aliases of p. However, pointer t could be aliased to any of the pointers b, c, d, e, g, h, or i, depending upon whether the last statement to update t that was executed before a14: p=t was b6; t=b, b7; t=c, b17; t=d, b18; t=e, a12; t=g; b3: t=h or b4: t=i; respectively. In other words, the aliases of t at a14 are schedule dependent, i.e., depend on the interleavings of transitions of different threads leading to the execution of a14. As a result, the set of may-aliases of p at a14 is the union of may-aliases over all valid interleavings of the statements of the threads leading to location a14 of T₁.

Thus the problem of computing (may-)aliases of a pointer in a given partition at a location in a thread boils down to computing precisely the valid set of interleavings. i.e., those that may contribute to the aliases of the pointer at the given location. However—generally speaking—determining whether an interleaving is valid in the presence of scheduling constraints imposed by synchronization primitives such as Locks, Wait/notify, Wait/NotifvAll, etc., as well as shared variables is undecidable.

It is known that the undecidability holds even for programs (a) with only two threads and (b) without any shared variables and (c) using only one synchronization primitive from among Locks, Wait/Notify or Wait/NotifyAll. Moreover, undecidability holds even when threads arc heavily abstracted as is often the case when carrying out dataflow analysis via abstract interpretation. This is but one reason why pointer analysis—or more broadly simple datalow analysis—which are efficiently decidable for sequential software programs become undecidable for concurrent programs.

Note that if in our example program, we ignore scheduling constraints imposed by locks and wait/notify statements, then all interleavings of the local statements of both threads arc possible. Consequently, T, and hence p, could be aliased to any of b, c, d, e, g, h, and i. Thus, in this example, ignoring synchronization constraints will give us precisely the same aliases as a flow and context insensitive analysis even if we carry it out in a flow and context sensitive manner. This is because in the absence of synchronization constraints, any assignment of a thread T₂ other than T₁ to a pointer in P irrespective of where it is located in T₂ (b3, b6, b6, b7, b17, or b18) can contribute to aliases of p at a14. Thus the bottom line is that in order to perform a meaningful flow and context-sensitive points-to analysis for concurrent software programs, we need to precisely determine the set of valid interleavings that could contribute to aliases of pointers in a given partition.

In order to see how synchronization constraints could affect aliases of pointers, we consider the statements b17: t=d and b18: t=e, both of which are guarded by statements b12 and b19 locking and unlocking count_lk, respectively. Since all statements occurring between lock and unlock statements for the same lock in different threads are executed in a mutually exclusive manner, we conclude that the execution of a14: p=t (where count_lk is always held) cannot be sandwiched between t=d and t=e. thus p=t is either executed before t=d or after t=e and so t cannot be aliased to d in order to capture the effects of such synchronization constraints we delineate transactions, where a transaction is an atomically executable piece of code in a thread. We encode the transactions of a concurrent software program in the form of a transaction graph as defined as follows.

We let P be a given partition. We say that a sequence of statements in a given thread are atomically executable if executing them without any context switch does not affect the points-to set of any pointer in P.

Definition (Transaction Graph) Let P be a concurrent software program comprised of threads and let V and E, be the set of control locations and transitions of Tᵢ, respectively. A transaction graph Π_{P} of P is defined as Π_{P}=(V_{P},E_{P}) where V_{P}⊂V₁× . . . ×Vₙ and E_{P}⊂(V₁, . . . , Vₙ)×(V₁, . . . , Vₙ). Each edge of Π_{P} represents the execution of a transaction m, by a thread Tᵢ. More specifically, an edge is of the form (m₁, . . . , mₗ, . . . , mₖ)→(n₁, . . . , nₗ, . . . , nₖ) where (a) starting at the global state (m₁, . . . , mₙ), there is an atomically executable sequence of consecutive statements of Tᵢ from mᵢ to nᵢ and (b) for all j≠i, mⱼ=nⱼ.

Each element of V_{P} is called a global state of P. There are two things to note: 1) A transaction of a thread is defined with respect to the global state of the given concurrent program and not the local thread location. This is because a region of code in a given thread T may or may not be atomically executable depending on the local states of threads other than T; and 2) the notion of atomically executable is application dependent. For concurrent pointer analysis, whether a sequence of consecutive statements constitute a transaction depends not only on the scheduling constraints but also on the partition considered.

Alias-Dependent Transitions. In construction the transaction graph a key role is played by the notion of alias-dependent statements.

Alias-Dependent Transitions. Given a partition P, we say that statements St₁ and St₂ of threads Tᵢ and T₂, respectively, are alias-dependent iff t₁εSt_{P} and St₂εP.

Intuitively, two transitions are alias-dependent if executing them in different relative orders might result in different points-to relations for pointers in P. For instance, in our example the statement a1: t=a is dependent with b5: t=c. Indeed which statement executes last before the execution of a14 governs the aliases of t. In order not to miss any aliases, the transaction graph should be constructed so as to allow a minimal set of interleavings that explore all allowed relative orders for each pair of alias-dependent transitions.

In general, for each pair of alias-dependent statements St₁ and St₂, we need to consider interleavings to explore both relative or ordering wherein St₁ is executed before St₂ and vice versa. This has the following important consequence. Suppose that in the current global state statement St₁ is enabled. Suppose also that it is dependent with statement St₂ of T₂. If, starting at the current global state, T₂ can transit to St₂ and execute St₂ then two possibilities arise, i.e., we can either execute St₁ first or let T₂ execute St₂ before ⊥₂ executes St₁. Since St₁ and St₂ are dependent these two scenarios may result in different aliases. Thus we need to allow a context switch before executing statement St₁ of T₁. It may, however, happen that St₂ is not reachable from the current global state, e.g., due to scheduling constraints. In that case, we do not need to consider a context switch at St₁ in the current global state as T₁ is bound to execute St₁ before St₂. This typically results in large transactions. We may now demonstrate how transaction delineation is governed by (i) synchronization constraints (ii) data constraints, and (iii) the pointer partition under consideration.

Synchronization Constraints

Locks. Taking into account scheduling constraints imposed only by locks, results in the transaction graph shown. The program starts in the initial state (⊥₁, ⊥₂) where ⊥ᵢ indicates that no statement of thread Tᵢ has been executed. There are two possibilities to consider. If Tᵢ executes first, then it can keep on executing until it first encounters a statement in St_{P}. This is because only transitions in St_{P} can affect points-to sets of pointers in St_{P} and the execution of other transitions can be ignored. Since a1εSt_{P}, (⊥₁, ⊥₂) has the successor (a₁, ⊥₂) via T₁. Similarly (⊥₁, ⊥₂) has the successors (⊥₁, b3) and (⊥₁, b17) via T₂

Next, we consider the state (a₁, ⊥₂). Via T₁, (a₁, ⊥₂) has the successors (a7, ⊥₂) and (a12, ⊥₂). Note that since our analysis is not path sensitive we are ignoring the conditional statement and taking both branches as possible execution paths. Via T₂, on the other hand, (a₁, ⊥₂) has the successors (a1 b3) and (a1 b17).

Now, we consider the state (a1 b3). In (a1 b3), thread T₂ holds lock plk which prevents T from acquiring plk at location a3, until after T₂ has released it at location b10. Thus, starting at global state (a1 b4), thread T₁ cannot transition a12. Hence even though a12 is alias dependent with b3, there is no need for a context switch at b3. As a result, (a1 b3) has only one successor, namely (a1 b4) via T₂. This is precisely how transactions resulting from lock constraints gets incorporated into the transaction graph. Indeed, it can be seen from the transaction graph that once the program P reaches state (a1 b3), thread T is forced to wait in a1 until T₂ reaches b11 after releasing plk. Similarly, we may compute the successors of other states.

Note that the reason why t can never be aliased to b at location a14 is that the sequence of statements b4, . . . , b10 constitute a transaction starting at global state (a1 b4) that is induced by locking constraints.

Transactions are State-Dependent. It is worth noting that whether a sequence of statements in a given thread constitutes a transaction depends also on the state of the other processes. For example, in global state (a1 b3) the sequence of statements b4, . . . , b10 constitute a transaction. However if Tᵢ has not executed a1, then b4, . . . , b10 cannot be executed atomically as there is nothing preventing the execution of a1 to be scheduled. This is one reason why transaction delineation needs to be carried out with respect to the global states of P instead of the local states of individual threads.

Wait/Notify Induced Constraints. So far in constructing the product transaction graph we have considered only mutual exclusion constraints imposed by locks. Consider now the send and wait statements b9 and a5 respectively. When thread Tᵢ reaches a location a5 it is forced to wait until T₂ executes the send statement b9. This imposes a causality constraint as any statement following a5 must be executed after any statement before b9. Thus for partition P₁ we need not consider interleavings of a7 with b3, b4, b6 and b7 as a7 will always be executed after b9. This example illustrates that for precise transaction delineation we need to incorporate synchronization constraints imposed by each of the standard synchronization primitives that we see in practice like locks, wait/notifies and wait/notifyAlls.

Shared Variable Constraints

We now show that t can never be aliased to c. This happens not because of scheduling constraints imposed by synchronization primitives but because of control flow constraints imposed by shared variable value. Indeed, in order for p to pick up the alias h the execution of the statement a14: p=t of T₁ has to be sandwiched between the execution of the statements b3: t=h and b4: t=i of T₂. However, in order for T₁ to execute p=t, pg_count<=LIMIT. But after T₂ has executed b3, and before it has executed b4 we must have pg_count=LIMIT, irrespective of how many threads are executing the Alloc_page and Dealloc_page routines, thereby yielding and inconsistency.

Thus, in delineating transactions, we need to also consider constraints imposed by shared variables into account.

Partition Specific Transaction Delineation

Different partitions yield different program slices which lead to different transaction graphs. For example, the transaction graph for partition Pᵢ differs from that for partition P₂

Delineating Transactions

A formal description of transaction delineation may be found elsewhere.

Incorporating Sensitivities

Effective summarization is key to scalable flow/context/schedule-sensitive analysis. A new characterization of aliasing via the notion of complete update sequences has been shown to be especially useful for summarization for alias analysis. The notion of complete update sequences also proves to be useful for concurrent pointer analysis as update sequences also proves to be useful for concurrent pointer analysis as update sequences can be tracked easily for concurrent software programs. Two key differences however, are that (i) interleaving constraints need to be taken into account, and (ii) update sequences need to be summarized at the transaction level as opposed to the function level for sequential programs. The transaction graph proves useful in meeting both these requirements.

Definition—Complete Update Sequence Let λ: lₒ, . . . , lₘ be a sequence of successive program locations and let r be the sequence lᵢ_{₁}: p₁=a₀, lᵢ_{₂}: p₂=a₁, . . . , lᵢ_{ₖ}: pₖ=aₖ₋₁ of pointer assignments occurring along λ. Then π is called a complete update sequence from p to q leading from locations lₒ, . . . , lₘ iff: 1) aₒ and pₖ are semantically equivalent to p and q at locations lₒ and lₘ, respectively; 2) for each j, aⱼ is semantically equivalent to pⱼ at lᵢ_{ⱼ}; and 3) fore each j there does not exist any (semantic) assignment to pointer a₁ between locations lᵢ_{ⱼ} and lᵢ_{ⱼ} . . . lᵢ_{_{j . . . 1}}: to a₀ between l₀ and lₙ: and to pₖ between lᵢ_{ₖ} and lₘ along λ.

Definition Maximally Complete Update Sequence. Given a sequence λ: l₀, . . . , lₘ of successive control locations starting at the entry control location l₀ of the given program, the maximally complete update sequence for pointer q leading from locations l₀ to lₘ along λ is the complete update sequence r of maximum length over all pointers p, from p to q (leading from locations l₀ to lₘ occurring along λ. If π is an update sequence from p to q leading from locations l₀ to lₘ we also call it a maximally complete update sequence from p to q leading from locations l₀ to lₘ.

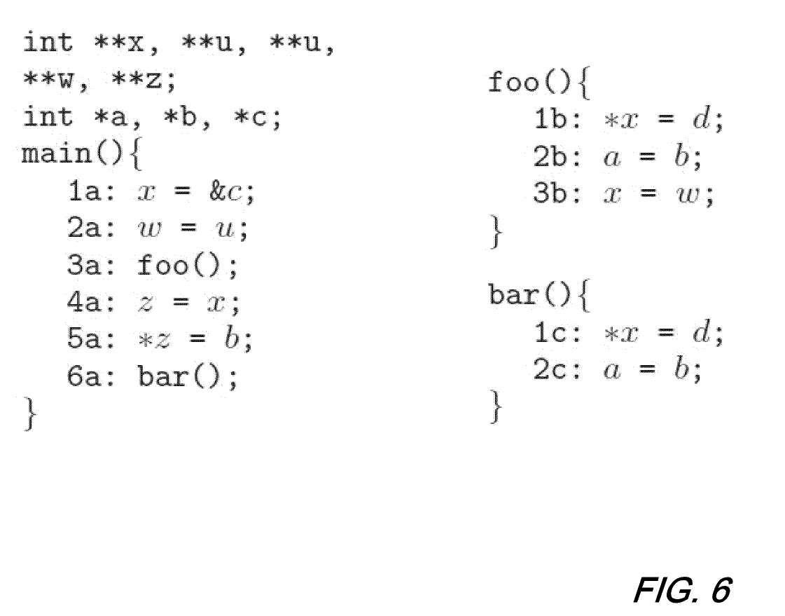

Typically, l₀ and lₘ are clear from the context. Then we simply refer to π as a complete or maximally complete update sequence from p to q As an example, consider the program shown in FIG. 6. The sequence 4a is a complete update sequence from b to a, leading from 1a to 4a, but not a maximally complete one. It can be seen that 1a, 4a is a maximal completion of 4a. Note that at location 4a, *x is not syntactically but semantically equal to a due to the assignment at location 2a. Maximally complete update sequences an be used to characterize aliasing.

Theorem 5 Pointers p and q are aliased at control location l iff there exists a sequence λ of successive control locations starting at the entry location l₀ of the given software program and ending at l such that there exists a pointer a with the property that there exist maximally complete update sequences from a to both p and q along λ.

Thus in order to compute flow and context-sensitive pointer aliases it suffices to compute functions summaries that allow us to construct maximally complete update sequences on demand. The key idea is for the summary of a function ƒ to encode local maximally complete update sequences in ƒ starting from the entry location of ƒ Then the maximally complete update sequences in context con=con=ƒᵢ . . . ƒₙ can be constructed by splicing together the local maximally complete update sequences for functions ƒ₁ . . . ƒₙ in the order of occurrence.

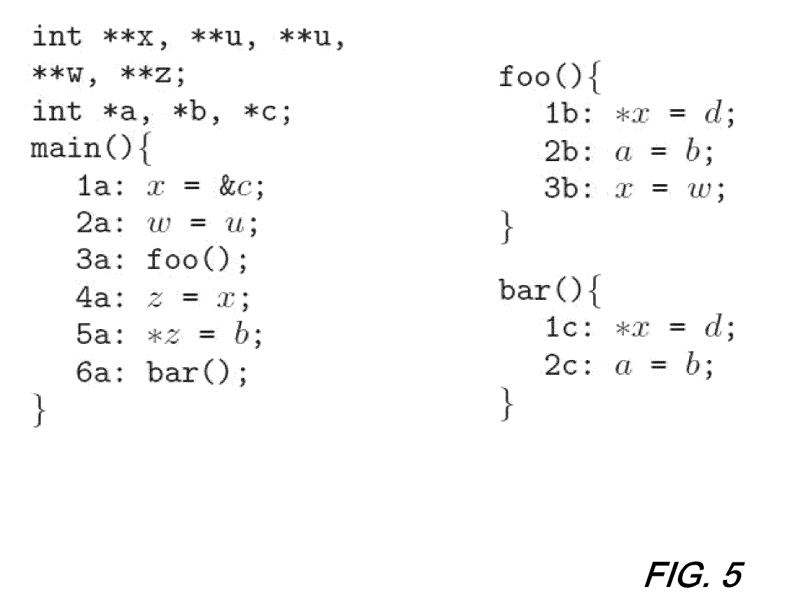

Consider the program Prog shown in FIG. 5. The sequential Steensgaard partitions of Prog are P₁={x, u, w, z} and P₂={a, b, c, d}. In this case, the Steensgaard points-to graph for Prog has two nodes n₁ and n₂ corresponding to P₁ and P₂, respectively with n₁ pointing to n₂.

Consider the Steensgaard partition P₁. Note that none of the statements of functions bar can modify aliases of pointers in P₁. This can be determined by checking that no statement of St_{P}_{₁} (computed via Algorithm 1) occurs in bar. Thus for partition P₁, summaries need not be computed only for functions main and ƒoo.

Accordingly, now consider function ƒoo. The effect of executing ƒoo on pointers in P₁ is to assign w to x. Thus the local maximally complete update sequence for x leading from the entry location 1b of ƒoo to 3b is x=w which is represented via the summary tuple. The last entry in the tuple encodes points-to constraints that are explained later. Note that with respect to each of the locations 1b and 2b, the summaries of ƒoo are empty as the aliases of none of the pointers in P₁ can be modified by executing ƒoo up to and including location 2b.

Now, suppose that we want the maximally complete update sequences for z leading from the entry location 1a of main to its exit location 6a. Since bar does not modify aliases of any pointer in P₁, the first statement encountered in traversing main backwards from its exit location that could affect aliases of z is 4a. Since z is being assigned the value of x, we now start tracking x backwards instead of z. As we keep traversing backwards, we encounter a call to ƒoo which has the already computed summary tuple (x, 3b, w, true) for its exit location, 3b. Since we are currently tracking the pointer x and since we know from the summary tuple that x takes its value from w, the effect of executing ƒoo can be captured by replacing x with w in our backward traversal and jumping directly from the return site 3a of ƒoo in main to its call site 2a. Traversing further backwards from 2a we encounter w=aat location 2a causing us to replace w with u. Since no more transitions modifying pointers of P₁ are encountered in the backward traversal, we see that w=a|,x=w,|z=xis a maximally complete update sequence and so (z, 6a,u, true) is logged as a summary tuple for main. Here, x=w is shown in square brackets to indicate a summary pair.

Let us now consider the set of pointers P₂. Suppose that we are interested in tracking the maximally complete update sequences for a leading from 1c to 2c in bar. Tracking backwards, we immediately encounter 2c causing a to be replaced with b. However, when we encounter statement *x=d at location 1c. If it does, then we propagate d backward else we propagate b. Note that what x points to cannot, in general, be determined for function bar in isolation as it might depend on the context in which bar is called. We therefore generate the two tuples t₁=(a, 2c, d, 1e: x→b) and t₂=(a, 2c, b, 1c: x→b) accordingly as x points to b or not at 1c, with the last entries in the tuples encoding the points-to constraints.

Definition (Summary) The summary for function ƒ is the set of tuples (p, loc, q, c₁, ̂ . . . ̂ cₖ) such that there is maximal complete update sequence from q to p starting at the entry location off and leading to location loc off under the points-to constraints imposed by c₁ . . . cₖ. Each constraint c is of one of the following forms (i)l:r→s (r points-to s at l); (ii) l:r→s (r does not point to s at l), (iii) l:r→s (r and s point to the same object at l) or iv) l:r→s (r and s do not point to the same object at l) respectively.

Top-down processing. As shown above, in processing a statement of the form *x=y at program location l, wee need to know before hand what x points to at l.

One observation is that if the summary computation for pointers in V_{P} is carried out in a top-down manner in increasing order of Steensgaard depth then if we encounter a statement of St_{P} of the form *x=y, such that x>y i.e., x occurs one level higher than y in the Steensgaard points-to hierarchy, the points-to sets for x would already have been computed. In that case, the complete update sequence can easily be propagated backwards. If, on the other hand, due to cycles in the points-to relation *x, x, and y occur in the same Steensgaard partition, then we track points-to constraints as given in the definition above.

Given a context, i.e., a sequence of function calls and a point, the aliases of a pointer at a location in a function can be determined by concatenating the local update sequence in each function up to the function call. Thus, if the context is ƒ₁, . . . , ƒₙ where function ƒᵢ₋₁ is called from within ƒᵢ we need local update sequences from the start of each function to the location corresponding to the function call at ƒᵢ₊. Then we compute tuple of the form. Note that tracking maximum update sequences makes the analysis flow sensitive by default. The two remaining sensitivities are flow and context sensitivities.

Context/Schedule Sensitive Alias Analysis

We start by defining the notions of schedule and context-sensitive analysis for concurrent programs. Since there are two or more threads present in a concurrent program, multiple variants of the context/schedule-sensitive analysis are possible. We now introduce two such notions.

Global Context-Sensitive Point-to Analysis

Given a pair of contexts (sequences of function calls in the two given threads leading to global state (c1, c2) and a pointer p of thread T₁, compute the points-to set of p at s in the given contexts.

Alternatively, we might be interested in computing points-to sets for just one thread.

Local Context-Sensitive Aliasing Problem Given a context in thread T of a concurrent software program P leading to local state c and a pointer p of T compute the points-to set of p at s in the given context.

We may advantageously define global schedule sensitive analysis where a schedule is a sequence of operations of two or more threads enumerated in the order of their execution. However a statement of thread T in P that is not in St_{P} is not dependent with, and hence is commutative with, any statement of a thread other than T. By exploiting this commutativity, we can re-order any schedule to generate an equivalent computation of the form tr₁, tr₂, . . . where trₙ is a sequence of statements of a single thread that constitutes a transaction as encoded in the transaction graph. When computing schedule-sensitive points-to sets we shall, therefore, resume that a schedule is specified as a sequence of transactions from the transaction graph.

Note that schedule sensitivity implies context sensitivity but the reverse need not be true. Based on flow, context and schedule sensitivities we can get various possible analysis, e.g., context-sensitive and schedule insensitive (CSSI) or context-sensitive and schedule-sensitive analysis (CSSS).

Summarization for Concurrent Pointer Analysis

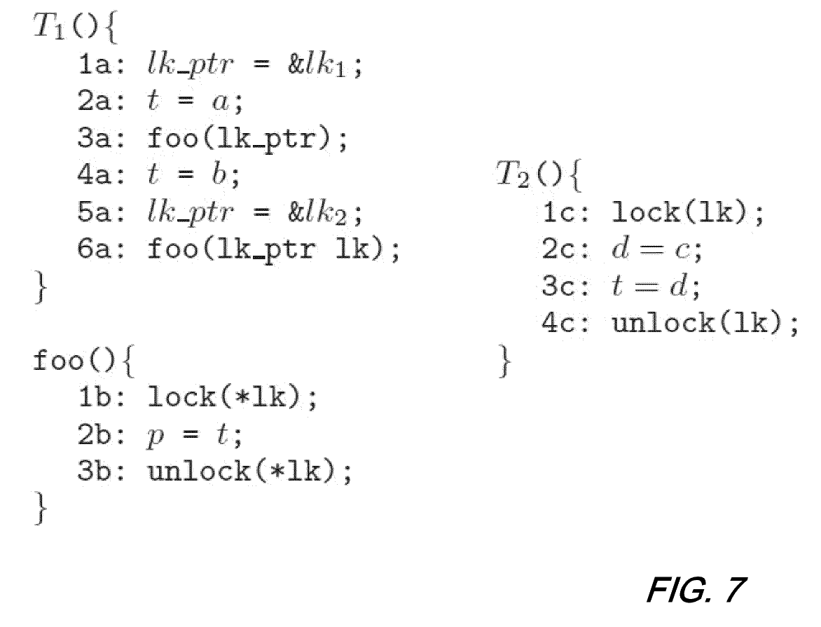

In computing the transaction graph we made no assumptions about thread contexts or schedules. In other words, the transaction delineated via the transaction graph are context and schedule insensitive. However, if we are given a context or a schedule then it is possible to identify larger and more refined transactions as is illustrated by the program shown in FIG. 7.

The transaction graph of P constructed via algorithm 1, is shown in the figure. Note that in state (2b, ⊥₂) in order to decide whether a context switch should be allowed at 2b, we need to check whether 2c which is alias-dependent with 2b, is reachable from the global state (2b, ⊥₂). One can see that 2c is reachable if and only if T₁ does not currently hold lock lk. However, since our construction of the transaction graph is context-insensitive the (must) lock-set at 2b is the empty set. This is because locks, viz, lk₁ and lk₂ are acquired in the two different contexts resulting from calls to ƒoo at location 3a and 5a respectively. Since the must-lockset is empty at location 2b, starting at global state (2b, ⊥₂) statement 2c is reachable by T₂ with T₁ remaining in 2b and so (2b, 2c) is a possible successor of (2b, ⊥₂).

However, increasing the sensitivity of the analysis often enables us to increase the granularity of transactions. Indeed, in the above example, suppose that we are interested in the aliases of p at the global state (2b, 3c) in contexts con₁:T₁>ƒoo₃ₐ and context-sensitive points-to analysis we can deduce that in con₁, T₁ holds lock lk at location 2b. This rules out (2b, 2c) as a successor of (2b, ⊥₂) in the transaction graph for the context pair (con₁, con₂). The full transaction graph of P for the context pair (con₁, con₂) leading to global state (2b, 3c) is given in the figure.

Key points worth noting is that the transactions in the context/schedule-sensitive transaction graph are: i) more refined, i.e., larger than those resulting from constructing the transaction graph (schedule/context-insensitive analysis; and ii) can be determined by concatenating smaller transaction from the transaction graph.

Given a context of one thread (local points-to analysis), a pair of contexts of two different threads (global points-to analysis) or a schedule (schedule sensitive analysis), the formal algorithm for determining the refined transaction graph is similar to that shown. One difference however, is that we only explore successors in the specified context and schedule.

Summarization for Schedule/Context Sensitive Analysis

The approach for summarization for schedule/context sensitive analysis is similar to the sequential case—the difference being that now instead of computing summaries over function boundaries, we compute them over transactions. However as noted previously, in general whether a piece of code in a given thread constitutes a transaction depends on the context/schedule under consideration. Our goal is to avoid computing summaries from scratch for every context/schedule query.

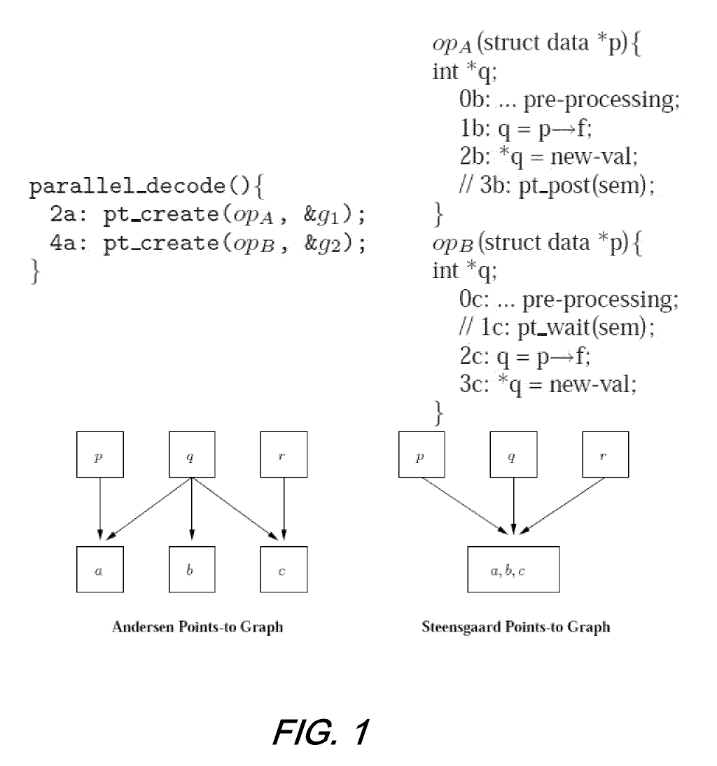

Towards that end, we exploit the property (ii) above that context/schedule sensitive transaction can be built by composing smaller transactions from the context/schedule-insensitive transaction graph. In other words, context/schedule insensitive transactions are the coarsest and form the building blocks for the larger context or schedule-sensitive transactions. Indeed in the example of FIG. 1, we see that in the transaction graph the transaction 2c₂, . . . , 4c₂ is composed of the transactions 2c₂ and 3c₂, 4c₂ of T₂.

A transaction is given by an entry statement of a thread and possibly several exit statements. Starting at global state (a,b) is a sub-graph of T₁ of the CFG is the sub graph defined as follows: T_{(a,b)}¹=(V_{(a,b)}¹, E_{(a,b)}¹) where V_{(a,b)}¹ is the set of statements c of T₁ such that there exists a path of the form (a,b), (a₁,b), . . . (aₙ,b), (c,b) in T_{P} and (d,e)εE_{(a,b)}¹iff ((d,b), (e,b))εE_{P}. Clearly, the transaction of T₁ of (a,b) is a directed graph with a single root, i.e., a and possibly many exit points, i.e, statements with no successors. Transactions of T₂ are defined analogously.

Definition (Transaction Summary) The summary for a transaction trans is the set of tuples (p, loc, q, c₁, ̂ . . . ̂ cₖ) such that there is maximal complete update sequence from q to p starting at the root of trans and leading to an exit location loc at ƒ under the points to constraints imposed by c₁, . . . , cₖ. Each constraint cᵢ is of one of the following forms: i) (r points to s at l); ii) (r does not point to s at l); iii) (r and s points to the same object at l); or iv) (r and s do not point to the same object at l) respectively

Since no context switch occurs inside a transaction, summaries computing maximal update sequences for transactions can be computed in exactly the same way as function summaries for sequential programs. Thus we compute summary tuple as given in the definition for each transaction of the transaction graph.

Computing Aliases from Transaction Summaries. Consider an instance of a global points-to context-sensitive analysis for global state (a,b) in contexts con₁ and con₂, of threads T₁ and T₂, respectively. Suppose that we want to decide whether two pointers p and q are aliased to each other at the given contexts. By theorem, it suffices to check whether there exists maximal update sequences starting at the initial global state (⊥₁, ⊥₂) of T_{P}, the transaction graph for P from the same pointers r to pointers p and q. To decide that we processed exactly as for sequential pointer analysis, the only difference being that we concatenate maximal update sequences from transactions instead of functions. We compute for pointers p and q the sets of M₁ and M_{q} comprised of pointers from where there exist update sequences in T_{P} to p and q. Finally p and q are aliased if and only if M_{P}∩M_{q}≠0. As such, our summarization proceeds by pre-computing summaries flow and context-insensitive aliases and concatenates them on the fly based on the transaction graphs generated by the query.

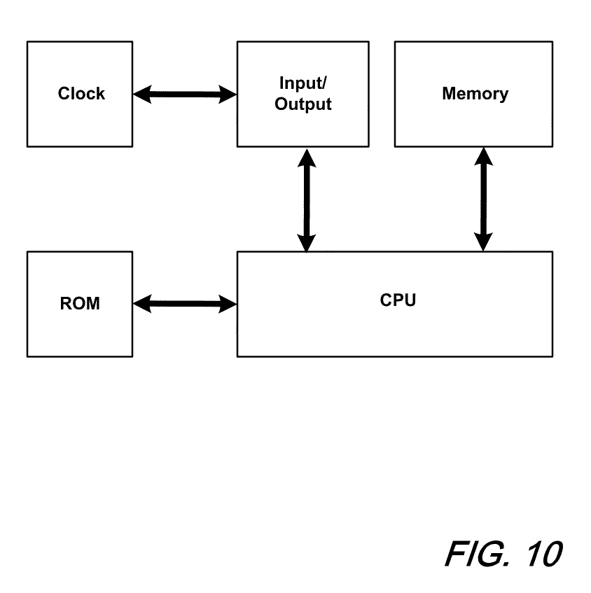

Finally, we note that as our method is computer-implemented, it is suitable for operation on a general purpose computer such as that shown in FIG. 10. Operationally, a concurrent software program is read into the system wherein the analysis proceeds. More particularly, a concurrent software program which may reside in RAM or other storage is read and analyzed by first identifying a set of pointers contained within the software program. The set of pointers are partitioned using a flow and context-insensitive analysis. Certain partitions are then selected wherein the selected partitions contain at least one shared pointer. Within the partitions, pointer partition-based transactions are delineated and summaries are produced and aliases generated.

At this point, while we have discussed and described the invention using some specific examples, those skilled in the art will recognize that our teachings are not so limited. Accordingly, the invention should be only limited by the scope of the claims attached hereto.

1. An computer implemented method for producing a set aliases of pointers contained within a concurrent software program, said computer-implemented method comprising the steps of:
determining a set of pointers contained within the concurrent software program;
partitioning the set of pointers into smaller subsets (clusters) of pointers;
determining a set of transactions contained within one or more clusters;
building summaries of the transactions fore each partition; and
generating a set of pointer aliases from the summaries so produced and outputting the set of generated aliases for the concurrent software program.

2. The method of claim 1 wherein said partitioning of the set of pointers is a Steensgaard analysis.
